(19) United States
(12) Patent Application Publication
(10) Pub. No.: US 2021/0329310 A1
(43) Pub. Date: Oct. 21, 2021

(54) SYSTEM AND METHOD FOR THE EFFICIENT GENERATION AND EXCHANGE OF DESCRIPTIVE INFORMATION WITH MEDIA DATA

(71) Applicant: JOSEPH WILSON, TORONTO (CA)

(72) Inventor: JOSEPH WILSON, TORONTO (CA)

(21) Appl. No.: 16/333,735

(22) PCT Filed: Sep. 12, 2017
(86) PCT No.: PCT/CA2017/051070

§ 371 Date: Jul. 9, 2019

Related U.S. Application Data
(60) Provisional application No. 62/395,749, filed on Sep. 16, 2016.

(51) Int. Cl. H04N 21/235; H04N 5/225; H04N 5/232; H04N 21/2743; H04N 21/4223

(52) U.S. Cl. CPC H04N 21/2353; H04N 5/22525; H04N 21/4223; H04N 5/232933; H04N 21/2743; H04N 5/232939

(57) ABSTRACT

Descriptive information for content items (in an image or other media data) is associated as metadata using methods, devices and systems of the present disclosure. Target devices associated with content items comprise beacons for transmitting beacon data to a capture device. The capture device may comprise a camera, for example, and a communication module to communicate with a beacon. In response to the capture of an image, descriptive information is associated with image data as metadata. The descriptive information may be obtained from the target device or, using the beacon data, from another communication device. One target device may be associated with more than one content item. For example, a target device may be a mobile phone and content items may be clothing, accessories or any styling associated with a mobile phone user. The images with metadata may be shared and the descriptive information displayed to others using the metadata.

### CROSS-REFERENCE

This application claims priority to or the benefit of U.S. Provisional Application No. 62/395,749 filed Sep. 16, 2016, the content of which is incorporated herein by reference.

### FIELD

The embodiments described herein are generally directed to systems and methods to generate and exchange descriptive information with media data, and more particularly, to the association of descriptive information as metadata to media data such as images, videos and sound.

### BACKGROUND

Metadata is a set of data that describes and gives information about other data, such as descriptive or technical information. Metadata is prominently used in association with digital media such as digital photographs, digital video and audio recordings, where metadata can be embedded in or otherwise associated with a digital file or files embodying content.

Technical metadata typically provides technical information about the properties of the digital media, such as but not limited to an identifier of the device that was used to capture the digital media, a timestamp representing the date and time that the digital media was created and/or modified, a format of the digital media and geographic location information of a location where the digital media was captured. Technical metadata is generally auto-associated with the file or files embodying the digital media when the digital media is captured by a device (e.g. a camera).

Descriptive metadata typically provides descriptive information depicting the content of the digital media, such as the names of individuals who appear as content, a brand name of an article within the content, keywords that are relevant to the content, a narrative description of the content, etc. Descriptive information is generally added manually to the file or files embodying the digital media after the digital media is generated.

Metadata can be stored in association with digital media data according to a number of different metadata standards. For example, a standard file structure and set of metadata attributes that can be applied to text, images and other digital media types is Extensible Metadata Platform (XMP). XMP is an open-source standard for the creation, processing, and interchange of standardized and custom metadata for all kinds of resources. XMP can be embedded in many types of file formats, such as JPEG, Tagged Image File Format (TIFF) and Portable Document Format (PDF), but can also be stored separately as a “sidecar” file to digital media data. Generally, metadata stored using these formats comprise technical information related to the digital media including but not limited to copyright information, the date of creation, the location of creation, source information, comments and special format instructions.

Another example standard is Exchangeable Image File Format (EXIF) which specifies the formats for images, sound, and ancillary tags used by digital cameras (including smart phones) and other digital media-capturing devices. EXIF specifically defines different metadata tags or fields where information, including technical and descriptive information, can be embedded within media data.

Whereas technical metadata is generally created and associated with content automatically upon creating the content, descriptive metadata is much less conducive to automatic creation and association. Descriptive metadata is generally manually generated and associated with digital media data. For example, after the creation of media data (e.g. capturing a picture, movie or sound and generating a digital file), descriptive textual information can be manually created by an individual to be associated with the generated media data using a keyboard, touch pad or the like.

The incorporation of media capturing devices into smart phones, tablets, and other digital devices has made it increasingly easy for users to capture digital media. Further, the growth of social media platforms capable of managing digital media has made the transfer of digital media between devices and users easy and efficient. Although social media tools provide for tagging a file when posting it to a social media site, users may not manually add descriptive metadata to digital media after capture outside of social media settings due to the effort required to do so. Further still, for individual users as well as entities that generate a lot of digital media (e.g. film and video producers, news agencies, television broadcasters and advertising agencies), it is not feasible to manually associate descriptive information with digital media as metadata as manually associating metadata is inefficient, time-consuming and cumbersome.

Beacons are a class of Bluetooth low energy (BLE) devices that transmit an identifier to nearby portable electronic devices. Beacon technology enables smart phones, tablets and other digital devices to perform actions and transfer data between devices when the devices are in close proximity each other. For instance, beacons offer a mechanism to quickly and efficiently transfer small amounts of data between portable electronic devices. Further, incorporation of beacon technology into personal portable devices has increased their availability to be used as passive transferors of data.

The aforementioned difficulties of manually entering metadata and the deficiencies in prior art applications to provide efficient and easy-to-use solutions has frustrated the ability of users to associate descriptive metadata with digital content. With an ever-increasing volume of content generated by users, the lack of a technology to add descriptive metadata to media data disturbs a user's ability to search, organize, and enjoy such content and further reduces the usefulness of such content when it is shared with others.

Improved systems and methods for associating descriptive information as metadata to media data are therefore needed. Embodiments should be user friendly and efficient and provide customized descriptive information for specific content. Such improved systems and methods should also facilitate subsequent transfer of digital media between electronic devices, thereby providing a subsequent user with easy access to the descriptive information.

### SUMMARY

Descriptive information for content items (in an image or other media data) is associated as metadata using methods, devices and systems of the present disclosure. Target devices associated with content items comprise beacons for transmitting beacon data to a capture device. The capture device may comprise a camera, for example, and a communication module to communicate with a beacon. In response to the capture of an image, descriptive information is associated with image data as metadata. The descriptive information may be obtained from the target device or, using the beacon data, from another communication device. One target device may be associated with more than one content item. For example, a target device may be a mobile phone and content items may be clothing, accessories or any styling associated with a mobile phone user. The images with metadata may be shared and the descriptive information displayed to others using the metadata.

In accordance with one aspect, there is provided a capture device having a processor coupled to a memory, an input device and a communication module, the memory storing instructions, which when executed by the processor, configure the capture device to: receive media data; receive beacon data from a target device proximate to the capture device when the media data is received, the beacon data received at the communication module of the capture device wirelessly from the target device; obtain descriptive information from the beacon data or using the beacon data where the descriptive information describes a content item; and associate the descriptive information with the media data as metadata. It is shown that either the beacon data comprises the descriptive information or the capture device is configured to obtain the descriptive information from the target device or another external communication device in accordance with the beacon data.

The capture device may be configured to: receive a representation where the representation corresponds to the descriptive information describing the content item; present the media data and the at least one representation on a display of the capture device; receive as input a selection of at least one of the at least one representation; and wherein the corresponding descriptive information of each selected representation is associated with the media data as metadata in response to the selection. Responsive to the selection of the representation, the capture device may be further configured to: request the corresponding descriptive information for the representation as selected from the target device or another external communication device; and receive the descriptive information.

The media data may be image data captured by an image input device (e.g. camera) of the capture device.

The content item may visually depicted in the media data (e.g. captured in the image).

The descriptive information may be an image of the content item in the image data.

The capture device may be further configured to transmit the media data and associated metadata to a third party server-based content sharing platform to be shared thereon. The capture device may be further configured to: increment a compensation value associated with a number of views of the media data and associated metadata, the number of views received from the third party server-based content sharing platform.

The capture device may be configured to: receive respective beacon data from respective target devices proximate to the capture device when the media data is received, the respective beacon data received at the communication module of the capture device wirelessly from the respective target devices; obtain respective descriptive information from at least some of the respective beacon data or using at least some of the respective beacon data where the respective descriptive information describes a respective content item; and associate the respective descriptive information as obtained with the media data as metadata. The capture device may be configured to: receive respective representations where each representation corresponds to descriptive information describing each respective content item; present the media data and the respective representations on a display of the capture device; and receive as input from a a selection of at least one of the representations; and wherein the corresponding descriptive information is associated with the media data as metadata in response to the selection. Each respective target device may comprise a beacon transmitting the respective beacon signal comprising the respective beacon data. Each target device may be associated with one or more content items. The capture device may comprise a camera to receive the media data as image data captured by the camera and the image data may include data for at least some of the content items associated with each target device.

A particular target device may be associated with one or more particular content items in a profile stored at another external communication device where each content item has respective descriptive information. The other external communication device may communicate the respective descriptive information to the particular target device or the capture device. The capture device either obtains the description information from the particular target device (e.g. as a component of the beacon data received from the particular target device) or from the other external communication device using the beacon data received from the particular target device. The capture device may be configured to request a representation associated with the particular target device from the other external communication device using the beacon data where the representation comprises a textual or visual identifier for a user of the particular target device. The profile may comprise a sharable portion for sharing information with capture devices, the sharable portion comprising representations for specific content items, each having associated descriptive information and wherein the capture device is configured to obtain the associated descriptive information upon receiving the media data and using the beacon data.

In accordance with another aspect, there is provided a computing device having a processor coupled to a memory and coupled to an input device, the memory storing instructions, which when executed by the processor, configure the computing device to: access a profile comprising a plurality of representations of content items, each representation of the plurality of representations having metadata providing descriptive information of a corresponding content item; transfer at least one of the plurality of representations to a sharable portion of the profile, the sharable portion of the profile accessible by a capture device over a network; and transmit a wireless signal by the communication module for receipt by the capture device, the wireless signal comprising instructions for the capture device to access the sharable portion of the profile and retrieve the descriptive information of each corresponding content item of the at least one representation transferred to the sharable portion of the profile.

In accordance with another aspect, there is provided a computer implemented method to share descriptive information with a computing device over a network, the method comprising: access a profile comprising a plurality of representations of content items, each representation of the plurality of representations having metadata providing descriptive information of a corresponding content item; transfer at least one of the plurality of representations to a sharable portion of the profile, the sharable portion of the profile accessible by a capture device over a network; and transmit a wireless signal by the communication module for receipt by the capture device, the wireless signal comprising instructions for the capture device to access the sharable portion of the profile and retrieve the descriptive information of each corresponding content item of the at least one representation transferred to the sharable portion of the profile.

In accordance with another aspect, there is provided a computing device having a processor coupled to a memory and coupled to an input device, the memory storing instructions, which when executed by the processor, configure the computing device to: identify media data having content to be rendered, the media data having associated metadata, the metadata comprising at least one tag linked to a time code of play in the media data, the tag associated with descriptive information of the content of media data; render the media data to an audience of users; upon reaching the time code of play in the media data, detect the tag linked to the time code of play; retrieve the descriptive information associated with the tag; and transmit the descriptive information to at least one user device over a wireless network such that the descriptive information is presented by the user device for viewing.

In accordance with another aspect, there is provided a computer implemented method to transmit metadata to a computing device over a network, the method comprising: identifying media data having content to be rendered, the media data having associated metadata, the metadata comprising at least one tag linked to a time code of play in the media data, the tag associated with descriptive information of the content of media data; rendering the media data to an audience of users; upon reaching the time code of play in the media data, detecting the tag linked to the time code of play; retrieving the descriptive information associated with the tag; and transmitting the descriptive information to at least one user device over a wireless network such that the descriptive information is presented by the user device for viewing.

Additional aspects and advantages of the present invention will be apparent in view of the description which follows. It will be appreciated that for any device or system aspect disclosed there will be complementary method and computer program product aspects disclosed or implied and vice versa. It should be understood, however, that the detailed description and the specific examples, while indicating preferred embodiments, are given by way of illustration only, since various changes and modifications within the spirit and scope of the invention will become apparent to those skilled in the art from this detailed description.

### BRIEF DESCRIPTION OF THE DRAWINGS

In order that the subject matter may be readily understood, embodiments are illustrated by way of examples in the accompanying drawings, in which:

FIG. 1 shows an exemplary system for attaching descriptive information received from at least one target device to media data, according to one implementation of the present disclosure;

FIG. 2 shows an exemplary block diagram of an embodiment of a target device 110;

FIG. 3 show an exemplary block diagram of an embodiment of capture device 130;

FIG. 4 shows an exemplary block diagram of platform 400;

FIG. 5 shows an exemplary block diagram of profile 118;

FIG. 6 shows an exemplary block diagram of capture module 402;

FIG. 7 shows an exemplary block diagram of media data 170 as a video file;

FIG. 8 shows a flow diagram for a process of associating descriptive information 148 to a media data 170 according to an embodiment;

FIG. 9 shows a system for providing video file 901 and sidecar file to users in accordance with one embodiment of the systems and methods described herein; and

FIG. 10 illustrates an example process for providing descriptive information to one or more user devices in accordance with one embodiment of the systems and methods described herein.

### DETAILED DESCRIPTION

The systems and methods described herein provide, in accordance with different embodiments, different examples for the efficient generation and exchange of descriptive information with media data. For example, the systems and methods described herein can be used to build on traditional digital media capture technologies (e.g. photography, video and audio) to add descriptive information about content of digital media to digital media files to provide users with additional knowledge about the content of the digital media in real-time. Descriptive information describing the content can be automatically provided (e.g. pushed) to users capturing digital media via wireless data transfer technologies, such as beacons, for attachment to the digital media.

The systems and methods described herein can also, for example, facilitate subsequent transfer of digital media with descriptive information providing knowledge of the content of the digital media between electronic devices, thereby providing a subsequent user with access to the knowledge. In one example, descriptive information about the content of a video can be provided to a subsequent user on the user's mobile device as the video is presented to the user, for instance in a movie theatre. The subsequent user can receive the additional knowledge describing the content of the video in a user-friendly form.

More specifically, in one embodiment, descriptive information describing content items (including but not limited to people, objects and/or services) can be created and managed within a profile of a platform accessible by a user on a computer or a smart phone. The user can share their descriptive information with subsequent users by adding their descriptive information to a sharable portion of the profile. Upon receiving a signal (e.g. a beacon signal) providing a storage location of the sharable portion of the profile, subsequent users can generate media data (e.g. an image, video or sound) including the content items and associate the descriptive information of content items to the media data as metadata. Subsequent users can then exchange the media data and associated descriptive information as metadata to promote the exchange of information describing the content of the media data. In one specific example described herein of the exchange of descriptive information with media data, media data and associated descriptive information can be synchronized and presented to subsequent users in an audience. In this example, the media data is presented on a display device for the user viewing and the associated descriptive information is presented on a computing and/or mobile device for user viewing and interaction.

More specifically, the systems and methods described herein provide, in accordance with different embodiments, different examples in which descriptive information of content items can be created, managed and shared by users through a profile or a platform accessible over a wireless network on a computing device. Users can selectively choose to share descriptive information with subsequent users of computing devices. In accordance with some aspects of the below-described embodiments, users of capturing devices that capture content and generate media data are provided with a system, device and method to associate descriptive information from target devices proximate to the capture device when the media data is generated. The users of the target devices may provide the descriptive information for association to gain increased public exposure through the sharing of the media data on the aforementioned sharing platforms, for example. In some embodiments, a user of a target device will include descriptive information of a person, object, service or the like for transfer to a capture device as the user of the capture device generates media data comprising the target device. By providing descriptive information of a person, object, service or the like to capture devices, the user of the target device may receive compensation from third parties for increasing the public exposure of the person, object, service or the like and potentially influencing users of capture devices and third parties that view the shared media data to, for example, make a purchase.

The systems and methods described herein also provide, in accordance with different embodiments, different examples in which descriptive information can be associated with media data as media data is generated and shared over a communication network on one or more content sharing platforms. For example, content sharing platforms commonly used to share media data (e.g. images, pictures, videos, etc.) include but are not limited to Facebook®, Instagram®, Tumblr®, Twitter®, online or web-based publication platforms (e.g. websites and/or blogs), online media distribution channels (e.g. YouTube™) and network mediums such as email and texting (e.g. short message service (SMS) or multimedia message service (MMS)).

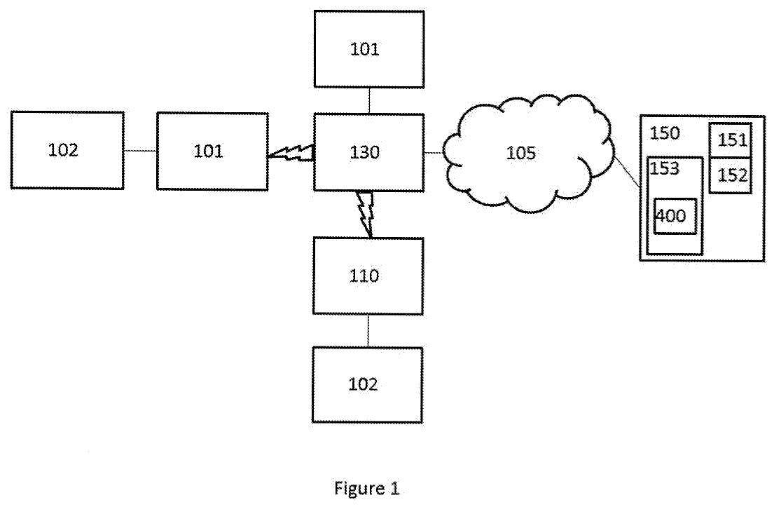

With reference to FIG. 1, an exemplary system 100 for attaching descriptive information received from at least one target device to a digital content piece will now be described. The system 100 generally includes capture user 101, a plurality of target users 102A, 102B and 102C, local network 105, wide area network 106, a plurality of target devices 110, capture device 130 and server 150.

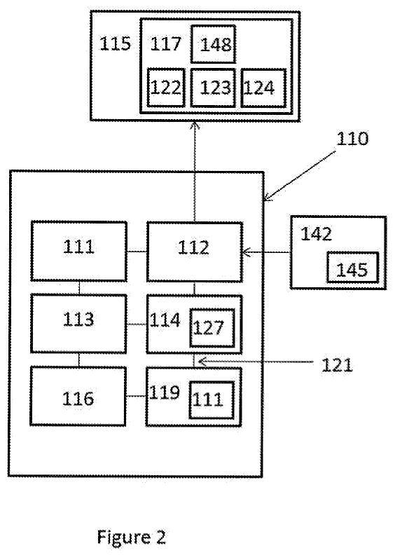

As shown in FIG. 2, each target device 110 may include processor 111, communication module 112, memory 113, location module 114, one or more input/output devices 116 and display 119. Signal 115 includes beacon data 117 which may comprise beacon information 122, instructions 123 and descriptive information 148 (described further below).

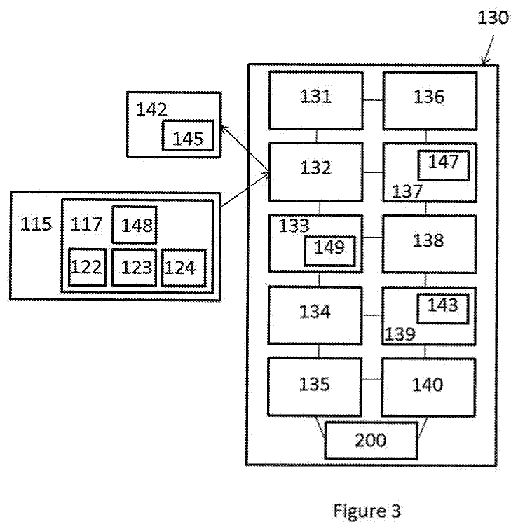

As shown in FIG. 3, capture device 130 may include one or more processors 131, one or more communication modules 132, memory 133, location module 134, one or more input/output devices 135, information collection module 136, presentation module 137, selection module 138, display 139 and expression module 140. It should be noted that in the embodiments described herein a capture device 130 can be a target device 110 and vice versa.

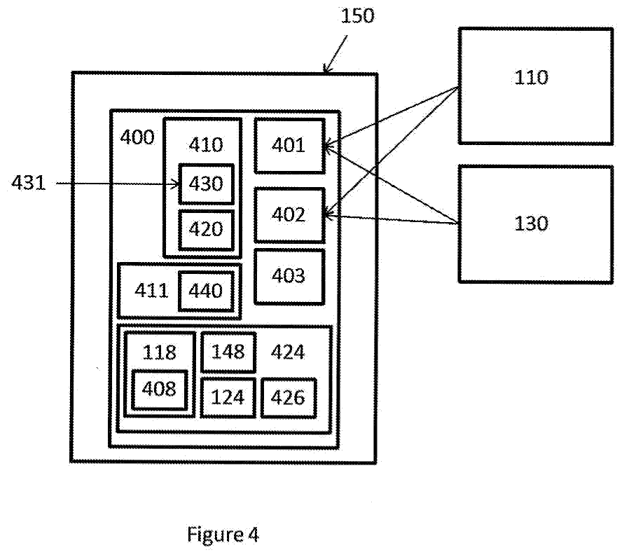

As shown in FIG. 4, server 150 may include processor 151, communication interface 152 and memory 153.

### Target Device 110

FIG. 2 is an exemplary block diagram of an embodiment of a target device 110 in accordance with one or more aspects of the present disclosure, for example, to provide descriptive information to capture device 130.

Target device 110 can be any communication device capable of transmitting a beacon signal 115. In the example shown in FIG. 1, target device 110 is a mobile phone. Target device 110 may be also be a Bluetooth® beacon (e.g. a class of low energy devices that transmit information to nearby portable electronic devices). Other examples of target device 110 may include a radio-frequency identification (RFID) tag, a tablet computer, a personal digital assistant (PDA), a laptop computer, a tabletop computer, a portable gaming device, a portable media player, an e-book reader, a watch or another type of computing or communication device.

Target device 110 (as a mobile phone) comprises one or more processors 111, one or more communication modules 112, memory 113, location module 114, one or more input/output devices 116 and display 119. Communication channels 121 may couple each of the components 111, 112, 113, 114, 116, 119 for inter-component communications, whether communicatively, physically and/or operatively. In some examples, communication channels 121 may include a system bus, a network connection, an inter-process communication data structure, or any other method for communicating data. It will be appreciated that when configured as a simpler beacon device (e.g. a communication device such as a RFID tag, Bluetooth beacon, etc.), target device 110 will have fewer and simpler components well-known to those in the art.

One or more processors 111 may implement functionality and/or execute instructions within target device 110. For example, processors 111 may be configured to receive instructions and/or data from memory 113 to execute the functionality of the modules shown in FIG. 2, among others (e.g. operating system, applications, etc.) Target device 110 may store data/information to memory 113. Some of the functionality is described further herein below.

Communication module 112 of target device 110 can be used to wirelessly communicate with external devices (e.g. capture device 130 or server 150) over network 105 by transmitting and/or receiving network signals on the one or more networks 105. In one embodiment, communication module 112 emits a beacon signal 115. Beacon signal 115 can be any wireless signal including but not limited to a Bluetooth signal. Beacon signal 115 is encoded with beacon data 117. Beacon data 117 can be encoded into beacon signal 115 in any manner known in the art.

In one embodiment, beacon data 117 can comprise beacon information 122 (e.g. an identifier). Beacon information 122 is any information that describes target device 110 or technical information associated with capture/transfer of beacon data from target device 110. For example, beacon information 122 can include an identifier of target device 110, a timestamp representing the date and time that beacon data 117 was generated and/or transmitted from target device 110 to a capture device 130, a location (e.g. a GPS location) of target device 110, or the like.

Beacon data 117 can also comprise instructions 123 for use by a receiving device (e.g. capture device 130) to establish a wireless connection with an external device (e.g. target device 110 or server 150) over network 105. In one embodiment, instructions 123 can be a code and/or descriptor used by capture device 130 to retrieve descriptive information 148 from a computing device (e.g. server 150) and display descriptive information 148 on capture device 130 to associate descriptive information 148 as metadata with captured content (e.g. media data 170). In this embodiment, descriptive information 148 can be stored on server 150 and retrieved by capture device 130 for association with captured content (e.g. media data 170) as metadata. In another embodiment, instructions 123 can be a code and/or descriptor that can be received by capture device 130 and directly associated with captured content (e.g. media data 170) as metadata. In this embodiment, the code and/or descriptor associated with captured content (e.g. media data 170) is used to lookup (e.g. retrieve and present) descriptive information 148 upon request either by capture device 130 or another computing device viewing the captured content (e.g. media data 170).

In another embodiment, beacon data 117 can also comprise (or be used to obtain such as using instructions 123) a representation 124. Representation 124 can be any textual or visual identifier of user 102 (e.g. a name, username or picture) and is used by a user 102 to associate descriptive information 148 from a target user 102 with content captured by capture user 130. Representation 124 can be presented on capture device 130 for user 102 to select to associate descriptive information 148 associated with content captured by capture device 130 (described further below). It will be understood that the representation 124 user need not be an individual person but may be an entity such as a business, government, institution or other entity. The representation 124 can be any textual or visual identifier of an object or object location, etc., with which the beacon of target device 110 is associated. Representation 124 may double (i.e. perform more than one function), for example, as descriptive information.

In another embodiment, beacon data 117 can also comprise descriptive information 148. Descriptive information 148 can be information that describes a content item 149 of media data 170 captured by capture device 110, including for example, representation 124. Content item 149 can be any of a person, entity, objects, things (e.g. goods or products), services (e.g. stylist, make-up/hair artist, etc.) or the like. Descriptive information 148 can be information that describes a content item 149 associated with content captured by capture device 110. Descriptive information 148 can include but is not limited to a brand name of an article worn by user 102, keywords that are relevant to an article worn by user 102, a narrative description of clothing and/or accessories worn by user 102, a narrative description of a geographic location, an image of the user 102, an image of an article, key data for a database storing descriptive data, the key providing access to the data, a hyperlink to a web address (e.g. to a manufacturer of an article worn by user 102) a link to social media platform page managed by user 102, etc. In another embodiment, beacon data 117 may comprise two or more instructions 123, representations 124 and descriptive information 148.

Memory 113 may be employed to hold an operating system and/or applications. Memory 113 may store instructions and/or data for processing during operation of target device 110. Memory 113 may take different forms and/or configurations, for example, as short-term memory or long-term memory. Memory 113 may be configured for short-term storage of information as volatile memory, which does not retain stored contents when power is removed. Volatile memory examples include random access memory (RAM), dynamic random access memory (DRAM), static random access memory (SRAM), etc. Memory 113, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Input/output devices 116 can be any device used by target user 102 to input/output information into target device 110 and are not restricted to devices providing input and output functions. For example, input/output device 116 can be a camera. Other examples of input/output device 116 can include any or one or more buttons, switches, pointing devices, a keyboard, a microphone, one or more sensors (e.g. biometric), etc.

Display 119 of target device 110 may be configured to present graphical user interface(s) (GUI) 111 in accordance with one or more aspects of the present disclosure. Target device 110 can receive inputs via GUI 111 from user 102 and generate an output signal to, for example, provide descriptive information 148 for receipt by one or more capture devices 130 and/or server 150.

Location module 114 may determine a location 127 of target device 110. Target device 110 may include or employ mechanisms to determine the location of target device 110 including but are not limited to: GPS(s), near field communication device(s), camera(s), pattern location metadata interpretation module(s), accelerometer(s), combinations thereof, and/or the like.

### Capture Device 130

FIG. 3 is an exemplary block diagram of an embodiment of capture device 130 in accordance with one or more aspects of the present disclosure, for example, to receive descriptive information 148 from at least one target device 110 (either directly or indirectly from a server 150) and to associate descriptive information 148 with media data 170 (either directly or indirectly through a server 150).

Capture device 130 can be any device capable of capturing content, associating descriptive information as metadata with the content and communicating the content with descriptive information over a network. In the example system shown in FIG. 1, capture device 130 is a mobile phone. Other examples of capture device 130 may be a tablet computer, a personal digital assistant (PDA), a laptop computer, a tabletop computer, a portable gaming device, a portable media player, an e-book reader, a watch, a camera with communication capabilities or another type of computing/communicating device.

Capture device 130 comprises one or more processors 131, one or more communication modules 132, memory 133, location module 134, one or more input/output devices 135, information collection module 136, presentation module 137, selection module 138, display 139 and expression module 140. Communication channels 141 may couple each of the components 131, 132, 133, 134, 135, 136, 137, 138, 139 and 140 for inter-component communications, whether communicatively, physically and/or operatively. In some examples, communication channels 141 may include a system bus, a network connection, an inter-process communication data structure, or any other method for communicating data.

One or more processors 131 may implement functionality and/or execute instructions within capture device 130. For example, processors 131 may be configured to receive instructions and/or data from memory 133 to execute the functionality of the modules shown in FIG. 3, among others (e.g. operating system, applications, etc.) Capture device 130 may store data/information to memory 133. Some of the functionality is described further herein below.

Communication module 132 of capture device 130 can be used to communicate with external devices (e.g. target device 110 or server 150) either directly (e.g. over a wireless Bluetooth connection) or over network 105 by transmitting and/or receiving network signals on the one or more networks 105. In one embodiment, communication module 112 receives beacon signal 115. In one embodiment, capture device 130 may receive a signal 115 from one or more target devices 110 when target devices 110 are positioned proximate to capture device 130.

It should be noted that herein “proximate” or “geographic proximity” refers to two devices being within a threshold distance. Threshold distance can be set to be any finite distance or can refer to a wireless transmission range. For example, two devices may be considered to be proximate to one another if one device is within a transmission range of the second device when the second device is transmitting a beacon signal (e.g. the first device can detect and receive the beacon signal transmitted from the first device). In another example, the threshold distance can be defined as a finite distance between two devices, as determined from a comparison of the latitude and longitude of each of the first and second device.

In another embodiment, communication module 132 of capture device 130 may emit a signal 142, where target devices 110 may be responsive to signal 142 from capture device 130 such that signal 142 triggers target devices 110 to emit signal 115. Communication module 132 can receive and/or detect signal 115 from one or more target devices 110.

In another embodiment, communication module 132 of capture device 130 can wirelessly connect capture device 130 with other wireless devices (e.g. target device 110 or sever 150) via Wi-Fi or other mechanisms of near-field, short-range wireless communication including but not limited to radio-frequency identification (RFID), near-field communication, etc.

Memory 133 may be employed to hold an operating system and/or applications. Memory 133 may store instructions and/or data for processing during operation of capture device 130. Memory 133 may take different forms and/or configurations, for example, as short-term memory or long-term memory. Memory 133 may be configured for short-term storage of information as volatile memory, which does not retain stored contents when power is removed. Volatile memory examples include random access memory (RAM), dynamic random access memory (DRAM), static random access memory (SRAM), etc. Memory 133, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Location module 134 may determine a location 147 of capture device 130. Capture device 130 may include or employ mechanisms to determine the location of capture device 130 including but are not limited to: GPS(s), near field communication device(s), camera(s), pattern location metadata interpretation module(s), accelerometer(s), combinations thereof, and/or the like.

Input/output devices 135 can be used by capture device 130 to receive (e.g. capture) content. In the example shown in FIG. 1, input/output device 135 is a camera used to capture an image(s) by capture user 101. The image(s) may be still or moving. In one embodiment, capture device 130 may include a video camera that captures video when activated by target device 110.

Other examples of input/output device 135 may include any or one or more buttons, switches, pointing devices, cameras, a keyboard, a microphone, one or more sensors (e.g. biometric), etc.

Display 139 of capture device 110 may be configured to present graphical user interface(s) (GUI) 143 in accordance with one or more aspects of the present disclosure. Capture device 130 can receive inputs via GUI 143 from capture user 101 and generate an output signal to, for example, transmit media data to one or more target devices 110 and/or server 150.

### Network 105

Network 105 is coupled for communication with a plurality of computing devices (e.g. capture device 130, target devices 110 and/or server 150). It is understood that representative communication network 105 is simplified for illustrative purposes. Additional networks may also be coupled to network 105 such as a wireless network between network 105 and either of capture device 130 and target devices 110 (not shown). Network 105 may be the Internet or other public or private networks.

### Server 150

Server 150 may include a server computer, a personal computer, a mobile phone, a tablet, or any other device capable of communicating with other devices, such as target device 110 and capture device 130. Server 150 may comprise a database 151 and be configured to store information such as but not limited to descriptive information 148 and one or more profiles 118 of users 101 and 102, for example.

### Platform 400

With reference to FIG. 4, an illustrative platform 400 will now be described. Platform 400 can be stored on a server (e.g. server 150) and accessible by any network accessible computing device (e.g. target device 110 or capture device 130) over a network (e.g. network 105) via an online web application interface or otherwise. Platform 400 may otherwise or also interface with users via a dedicated client application interface stored and executed by the user's device (e.g. target device 110 and/or capture device 130).

In the embodiments disclosed herein, platform 400 comprises a profile module 401, a capture module 402 and a sharing module 403. Profile module 401 provides GUIs 111 for users 101,102 to create, access and/or update user profile information and create, receive and manage personal and content descriptive information. Capture module 402 provides GUIs 143 for users 101,102 to direct device 130 to receive (e.g. capturing) content from other devices, generate media data and associate descriptive information with the media data. Sharing module 403 provides GUIs 111,143 for users 101,102, respectively, to post, share and/or view media data with associated descriptive information.

Platform 400, implemented using the devices, systems and methods described herein, may be used for the efficient generation and exchange of descriptive information with media data. The following three example use scenarios for platform 400 are described as examples.

In a first example, platform 400 may facilitate users to manage and promote descriptive information of objects, services and persons (including themselves) to other users within a geographic proximity (e.g. within a threshold distance, as described herein) using wireless data transfer techniques. Descriptive information of a variety of objects, services and individuals are envisioned, such as but not limited to personal clothing information, clothing accessory information, hairstyle information, headwear information, and other personal object information. Further, the descriptive information can include brand name, color, size, style, manufacturer name, purchase location, and a hyperlink to a website to view further information and/or purchase the object/service. Accordingly, platform 400 can provide capture users with knowledge of the objects, services and people in their surroundings in the real world and to purchase the objects/services in real-time. Interfaces may be provided to link users with on-line commerce platforms for such objects/services. For example, when viewing the image, a user may be presented with the descriptive information (for example, by selectively overlaying at least some of the information on the image). The user may tap or otherwise invoke the interface and be directed to an on-line commerce platform. This platform may provide further descriptive information and/or facilitate purchasing.

In a second example, platform 400 may provide users to capture and access descriptive information of objects, services and people surrounding them in the real world as the user captures a digital photograph, video or audio recording of the object, service or person and associate the descriptive information with the digital photograph, video and/or audio recording. For example, users could automatically receive descriptive information of objects, services and/or people surrounding them in the real world from target devices and selectively associate the descriptive information with the digital photo, video or audio recording as metadata for subsequent transfer and sharing.

It will be understood that the collection or capture and communication of information as described may be useful in other contexts and for other purposes and not just for individuals in a consumer context. For example within a plant or facility (e.g. manufacturing, power generation, refinery, commodity extraction (mine, quarry, rig, etc.), etc.), institution (hospital, government, university), office, hotel, residence, etc. equipment or other objects therein may be associated with beacons. The beacons may provide descriptive information (including technical information) which may be captured such as with a camera device and associated with the image for communication. The information may be useful for repair or replacement purposes, inventory compilation or confirmation, design configuration (or redesign), accident investigation (scene layout and inventory), etc.

In a third example, platform 400 may provide for the automatic transmission (e.g. push) of descriptive information pertaining to objects, services and/or people displayed in a video to user devices in an audience as the video is rendered to the audience. Accordingly, users in the audience can simultaneously access descriptive information of objects, services and people presented in the video on their devices in real-time as the video is displayed, thereby providing users with knowledge of the objects, services and people presented in the video.

It will be understood that the automatic capture and transmission of information (e.g. push) may be useful in other contexts and for other non-commercial purposes without the use of cameras and other media capturing technologies. For example, capturing descriptive information from beacons in a surrounding area and subsequent automatic transmission of the descriptive information may be useful within settings where personal security is provided.

Various embodiments of the three examples described above are provided below.

### Generation and Promotion of Descriptive Information Within a Profile

Profile module 401 generally comprises a network accessible module 410, a user management module 411 and a database 412.

Network accessible module 410 has a user interface 420 accessible from a computing device (e.g. target device 110 or capture device 130) that facilitates users (e.g. users 101,102) access to the functions and features of platform 400. In one embodiment, network accessible module 410 comprises an upload engine 430 for uploading user content and preferences/selections 431 to a user database 424. User database 424 may include a content originator manager 426 whereby the manufacturer/retailer of an object, service provider or the like, for example, represented by a representation 404 in profile 118 can create a representation for use by user 101,102.

User management module 411 has a user interface 440 that provides for user manipulation of representations 124 stored in database 424 as well as selection of information to be shared by the platform 400.

User management module 411 can present various graphical user interfaces on, for example, display 119 of target device 110 or another computing device (not shown) associated with user 102, to provide a profile 118 according to the following examples. It should be understood that although the following description provides an example of profile 118 providing a digital repository for information describing clothing and other personal objects (e.g. accessories, hats, shoes, etc), profile 118 can provide a repository for information describing any group of objects or services, etc.

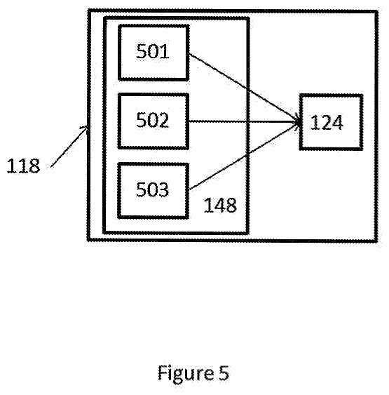

Turning to FIG. 5, profile 118 comprises user profile information 501, user descriptive information 502 and content item descriptive information 503 (which taken alone or in combination may comprise description information 148). Profile 118 facilitates user 101,102 to create, access and/or update user profile information 501 as well as create, receive and manage user descriptive information 502 and content item descriptive information 503 as described in the following embodiments.

User profile information 501 generally includes information to personally identify user 102, such as but not limited to a name, height, weight, home address, email address, profession, school, title, phone number(s), social media information (e.g. link to Facebook® page, link to Instagram® page, Twitter® handle, etc.).

User descriptive information 502 generally includes dynamic (e.g. frequently changing) information that user 102 uses to describe their personal appearance, such as but not limited to clothing that user 102 owns, clothing that user 102 is wearing, jewellery that user 102 owns, accessories that user 102 owns, current make-up types, hair color, style of hair cut, headwear, footwear, clothing accessories, jewellery, etc.

Content item descriptive information 503 generally includes information to describe a specific content item (e.g. a person, object, service or the like) present in the media data 170 such as but not limited to a manufacturer, a brand name, a purchase price (e.g. manufacturer suggested retail price (MSRP)), object availability in stores, a hyperlink to a website where the object is available for sale, a hyperlink to manufacturer/retailer Facebook® page, a hyperlink to manufacturer/retailer Instagram® page, manufacturer/retailer Twitter® handle etc. Content item descriptive information 503 may also include services information such as make-up artist, hair or wardrobe stylist, personal trainer, dietician, personal coach among other service providers, etc.

Profile 118 may be organized into a plurality of pages that user 102 can navigate to organize and/or manage representations 404 for the user 102 and each of a plurality of content items 149. Representations 404 represent the user or a content item 149 and/or characteristic of a content item 149 that user 102 desires to manage/organize according to the embodiments disclosed herein. For example, a representation 404 can be a visual depiction of a corresponding physical object and may have associated (e.g. tags and/or metadata) content item descriptive information 503 describing properties and or characteristics of the content item 149 as described above. Representation 404 can also be a numeric code (e.g. barcode), a quick-response (QR) code or any other unique alphanumeric code or depiction to represent a corresponding content item 149.

According to one embodiment, representation 404 can include two-dimensional and/or three-dimensional visual depictions of corresponding physical objects. In the case of three-dimensional representations, representations 404 of objects may be presented using three-dimensional graphics on either two-dimensional or three-dimensional display devices. This may permit, for instance, for representations 404 to be rotated to provide different viewing perspectives of their corresponding object.

Representations 404 may be added to profile 118 by a number of different methods. In one example, representations 404 can be added to profile 118 from a merchant and/or manufacturer at the time of purchase of a corresponding content item 149. For example, in one embodiment, a micro beacon (e.g. RFID tag) may be incorporated into the corresponding content item 149 (e.g. in the form of a label) where, upon purchase of the corresponding content item 149, representation 404 (and any associated descriptive information) is added to profile 118 by target device 130. For example, in one embodiment, representation 404 can be added to profile 118 through platform 400 accessible on target device 130 after capturing a code from the merchant/retailer at the point-of-sale (e.g. scanning a barcode/QR code, etc.), receiving a code via wireless transmission from the retailer/merchant, receiving a code as input from user 102, etc). In this example, representation 404 may be an authenticated representation (e.g. the representation and/or additional information may comprise authentication information 410 used to verify that the corresponding content item is authentic). Authentication information 410 can be a consolidated short-code (e.g. an alphanumeric code) provided as descriptive information for user 101 to retrieve representation 404 from a merchant/manufacturer to receive representation 404. After receiving a code, capture device 102 may access a server (not shown) to download representation 404 and install representation 404 into profile 118, for example.

In another embodiment, representations 404 can be created by users 102 and added to profile 118. For example, a user 102 can capture a visual depiction of the corresponding content item 149 as representation 404 and manually associate content item descriptive information 503 using platform 400. Platform 400 can provide template fields of descriptive information for the creation of representations 404 such as but not limited to: designer, manufacturer, commercial description, colour, style, SKU, cost, weight, size(s) (e.g. available), etc.

When user 102 chooses to share content item descriptive information 503 with capture devices 130, user 102 can add representations 404 representing specific content items 149 to an sharable portion 408 of profile 118 via GUI 111, where content item descriptive information 503 of content items 149 in sharable portion 408 are transmitted to capture devices 110 upon request from capture devices 110 (e.g. upon capturing/generating media data 170).

For example, in one embodiment, user 102 can view a graphical user interface 111 on display 119 of target device 110 depicting representations 404 corresponding to the clothes that user 102 owns. In this example, user 102 can select (e.g. click and drag) each representation 404 corresponding to an article of clothing or an accessory (e.g. content item 149) that user 102 is wearing or proposes to wear to associate the representations 404 and content description information to the user's sharable portion 408. In turn, sharable portion 408 is associated with beacon signal 115 of target device 110 and descriptive information 148 such that, when complete, representations 404 and/or description information 148 is transmitted to the user target device 110 for sharing via the beacon signal 115.

When user 102 desires to transmit beacon signal 115 and thereby facilitate transmission (e.g. showcasing or sharing or promoting) of descriptive information 148 (including any of user profile information 501, user descriptive information 502 and content item descriptive information 503) representative of the clothing and accessories (e.g. content items 149) that user 102 is wearing, for example, to capture devices 130, profile 118 can provide GUIs 111 to enable and disable transmitting (e.g. emitting) of beacon signal 115 from target device 110. Disabling emission of signal 115 inhibits a target device 130 from receiving any one of or any combination of user profile information 501, user descriptive information 502 and content item descriptive information 503 (cumulatively making u descriptive information 148). Further, platform 400 provides that any of user profile information 501, user descriptive information 502 and content item descriptive information 503 can be individually accessible by target device 130. Further still, in another embodiment, user 102 can select times to enable and disable transmitting signal 115 from target device 115, where processor 111 controls transmitting signal 115 from communication module 112 according to the selected times. It should be noted that user 102 can control access to any and all of user profile information 501, user descriptive information 502 and content item descriptive information 503 by target devices 130.

In another embodiment of platform 400, platform 400 can comprise privacy settings 511 to inhibit signal 115 from being received and decoded by capture devices 130. For example, in this embodiment, user 102 can restrict access to any or all of user profile information 501, user descriptive information 502 and content item descriptive information 503 (cumulatively descriptive information 148) so that only “friends” can see/receive user profile information 501, user descriptive information 502 and content item descriptive information 503 or require permission from user 102 to be granted before a content item can be tagged by a capture device with any or all of user profile information 501, user descriptive information 502 and content item descriptive information 503 from target device 110.

For example, in an embodiment where beacon signal 115 comprises instructions 123 for retrieval of descriptive information 148 from server 150 (e.g. when profile 118 is stored on server 150), instructions 123 can provide for capture device 130 to submit an identifier of capture user 101 to server 150 for server 150 to verify that capture user 101 is authorized by target user 102 to receive description information 148 from profile 118 of target user 102.

In another embodiment, platform 400 can provide a time limit for transmitting beacon signal 115 or a duration for transmitting beacon signal 115 from target device 110 so that beacon signal 115 is only transmit during a set period of time. In one embodiment, configuration of the sharable portion 408 of profile 118 is stored to generate a timeline archive of the user 102. Each profile 118 may have a unique code to retrieve the descriptive information 148 or a time may be provided with a common code for the target user 102.

In another embodiment, target device 110 may receive a notification 420 (e.g. from server 150 or directly from capture device 130) when descriptive information 148 is associated with media data 170.

Alternatively, capture device 130 may also send a notification 421 to server 150 upon capturing descriptive information from target device 110 and/or associating descriptive information from capture device 110 to a content item. Notification 421 can be time-stamped (e.g. a time of generation of notification 421 can be attached as metadata) such that when notification 421 is provided to server 150, server 150 can store notification 421 in memory and track a number of times that capture devices 130 receive descriptive information from target device 110 and/or associate descriptive information from target device 110 with a content item.

Time-stamped information stored by server 150 by way of notification 421 can be correlated to descriptive information 148 associated with media data 170 such that users 102 of target devices 110 can be assessed as “influencers” of content items 149 associated with descriptive information 148 active in profile 118. In one example, manufacturers/retailers can provide monetary reimbursement to target user 101 for influencing the transfer of media data 170 through server 150 with descriptive information 148 associated thereto, for example.

### Receipt of Descriptive Information and Selective Association with Media Data

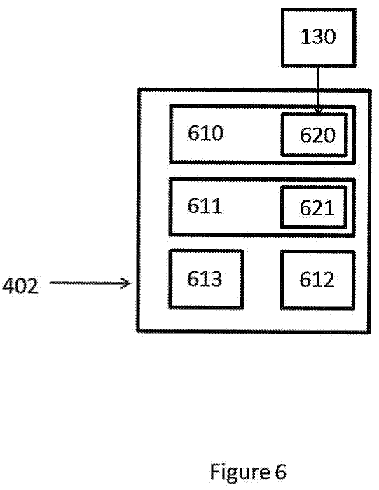

Referring to FIG. 6, capture module 402 generally comprises a network accessible module 610, a user capture module 611, associator 612 and database 613.

Network accessible module 610 has a user interface 620 accessible via a computing device (e.g. capture device 130) that facilitates user (e.g. capture user 101) to capture content, generate media data 170 and associate descriptive information 148 to media data 170 according to the following embodiments.

User capture module 611 has a user interface 621 that provides for capture user 101 manipulation of received content, generated media data 170 and descriptive information 148 (as described below).

In one embodiment, communication module 132 of capture device 130 can receive beacon signal 115 upon activation of input/output device 135 by capture user 101. In this embodiment, capture user 101 activation of input/output device 135 of capture device 130 to capture an image (either still or moving) triggers communication module 132 to receive or process one or more beacon signals 115 received from one or more target devices 110 proximate to capture device 130. In one embodiment, input/output device 135 is a camera and activation of input/output device 135 triggers capture device 130 to capture digital content and generate media data 170 (e.g. a digital image file (either static or moving), a digital audio file or the like). In another embodiment, capture user 101 activation of input/output device 135 of capture device 130 to capture an image (either still or moving) triggers communication module 132 to automatically receive or process one or more beacon signals 115 from one or more target devices 110 proximate to capture device 130. In another embodiment, capture user 101 activation of input/output device 135 of capture device 130 to capture an image (either still or moving) triggers communication module 132 to receive or process one or more beacon signals 115 from one or more target devices 110 proximate to capture device 130 in real-time. In another embodiment, capture user 101 activation of input/output device 135 of capture device 130 to capture an image (either still or moving) triggers communication module 132 to receive or process one or more beacon signals 115 pushed from one or more target devices 110 proximate to capture device 130.

Upon receipt of beacon signal 115 by communication module 132, beacon signal 115 is transferred from communication module 132 to information collection module 136 where beacon signal 115 is decoded to extract beacon data 117 embedded therein. Beacon data 117 can be encoded into beacon signal 115 in any manner known in the art.

As described above, beacon data 117 can comprise instructions 123 for use by capture device 130 to establish a wireless connection with target device 110 and/or server 150 over network 105 to retrieve descriptive information 148 of target user 102. In another embodiment, capture device 101 can receive beacon data 117 from each of a plurality of target devices 110A, 110B, 110C, each beacon data 117 comprising a representation 124 of a respective target user 102 (e.g. target user 102A, 102B and 102C) proximate to capture device 130 upon capture device 130 capturing content and generating media data 170.

In one embodiment, instructions 123 for use by capture device 130 to establish a wireless connection with target device 110 or server 150 over network 105 can be transmitted in response to a request 145 (via signal 142, see FIG. 3) transmitted from capture device 130 to target device 110.

Either in response to request 145 or upon capture of content and generation of media data 170, capture device 130 can receive representation 124 of descriptive information 148 from a target device 110 or server 150. As described above, representation 124 can be any visual depiction to visually identify user 102 (or the object or other thing with which the beacon of target device 110 is associated). In one example, representation 124 is an image of target user 102. In another example, representation 124 is a name of target user 102. Representation 124 is used to identify a specific target user 102 from the plurality of target users 102 proximate to capture user 101 when capture user 101 captures beacon signal(s) 115. Representation 124 can be a picture or other identifying feature (either textual (e.g. a name, username or code) or pictorial (e.g. a picture of a face)) of user 102 of target device 110.

Representation 124 is received from target device 110 or server 150 via communication module 132 and communicated to display 139 to present to capture user 101.

As described above, profile 118 can be a collection of information (e.g. including descriptive information 148) entered by target user 102 in platform 400 for storage on one of target device 110 and server 150. Profile 118 can include customizable information editable by user 102 for inclusion as descriptive information 148 as metadata in association with media data 170.

Upon receipt of representations 124, capture device 130 presents representation 124 on display 139. In one embodiment, capture device 130 is proximate to more than one target device 110 upon capturing content and generating media data 170 as described above, and therefore receives a plurality of representations 124, each representing a respective target user 102. In this embodiment, display 139 can present a list of representations 124 on display 139 of capture device 130. Representations 124 be listed randomly on display 139 or can be listed in order according to a distance between target device 110 and capture device 130 at the time of receipt of beacon signal 115 from target device 110 by capture device 130. In one embodiment, representations 124 corresponding to target users 102 of target devices 110 within the shortest distance to capture device 130 can be presented at the top of the list. In another embodiment, a distance between target device 110 and capture device 130 at the time of receipt of beacon signal 115 from target device 110 by capture device 130 is determined by accessible module 610 by measuring a strength of beacon signal 115 upon receipt at capture device 130, where stronger beacon signals 115 represent target devices 110 closer to capture device 130.

It should be noted that, in one embodiment, capture device 130 can automatically transmit descriptive information 148 to server 110 upon receipt from target devices 110. For example, prior to capturing descriptive information 148 from target devices 110, user 101 can select to automatically transmit descriptive information 148 to server 110. In another embodiment, prior to capturing descriptive information 148 from target devices 110, user 101 can select to automatically transmit descriptive information 148 to server 110 without associating descriptive information 148 to content.

Selection module 138 of capture device 130 can receive a user selection of at least one representation 124 from the list of representations 124 presented on display 139. User selection of representation 124 indicates that user 101 would like to associate descriptive information 148 in sharable portion 408 of profile 118 of target user 101 with the content captured (e.g. media data 170) by capture device 130. It should be noted that user selection can also occur prior to receipt of descriptive information 148 (e.g. user 101 can select to associate and/or automatically transmit descriptive information 148 to server 110 prior to receiving descriptive information 148).

For example, upon capture of an image by user 101 using capture device 130, selection of at least one representation 124 from the list of representations 124 presented on display 139 results in associating the descriptive information 148 in active module 408 of profile 118 of target user 102 with the captured image file (e.g. media data 170) now stored on capture device 130 (as described below). It should be noted that in the event that capturing content at capture device 130 results in the receipt of a plurality of representations 124 from a plurality of target devices 110A, 1106, 110C, for example, any one or more representations 124 can be associated with the media data 170 generated at capture device 130.

Upon capture user 101 selecting at least one representation 124, information collection module 136 can transmit a request 604 to server 150 or target device 110 to request descriptive information 148 of profile 118 corresponding to the representation 124 selected. For example, request 604 can provide server 150 with beacon information 122 (e.g. an identifier) received embedded in beacon signal 115 to specify the target user 102 (and profile 118) from which description information 148 is being requested. It will be understood that capture device 130 may be configured to operate without requiring a capture user 101 to select at least one representation 124 to obtain the respective descriptive information 148. As noted above, respective descriptive information 148 may be received from the target device as part of the respective beacon signal received from the target device 110 or respective descriptive information 148 may be received from the target device 110 or server 150 using data from a respective beacon signal (e.g. in a request sent from the capture device 130) automatically, without user selection. It will be appreciated that giving capture user 101 user selectivity via a display of one or more representations 124 may be advantageous to permit control by the capture user 101, to reduce the amount of descriptive information to be associated with the capture, to show capture user 101 which beacon data was available/captured by device 130, etc. It may be that insufficient beacon data was captured and capture user 101 may wish to try again. Capture user 101 may reposition capture device 130 to improve a chance to receive a desired beacon signal.

According to some of the various embodiments, descriptive information 148 may be textual information describing content items 149 in media data 170 including but not limited to: a name of the target user 102, a brand of clothing that the user 102 is wearing, a brand of an object, an identifying characteristic of an object (e.g. colour, shape, size, etc.), etc.

In another embodiment, descriptive information 148 can be an image file. According to some of the various embodiments, the descriptive information 148 may include images such as but not limited to: an image of user 102, an image of an object; an image of an article of clothing being worn by user 102.

In one embodiment, descriptive information 148 can be associated with media data 170 as metadata. For example, if media data 170 is a static image file (e.g. JPEG, TIFF, GIF, etc), descriptive information 148 can be stored in association with media data 170 according to current metadata standards for static image file types (e.g. descriptive information 148 can be stored in the descriptive information field of XMP metadata; descriptive information 148 can be stored in the descriptive information field of EXIF standard; creation of new tag; coded as extension to title of file; etc.)]

It should be understood that herein the term “directly associated” refers to two potential mechanisms of linking descriptive information 148 to media data 170: descriptive information 148 being embedded in the media data 170 and descriptive information 148 being associated with the media data 170 as a separate file (e.g., in a sidecar file). Further, “indirectly associated” refers to the association of instructions with media data 170 for a user to use to retrieve descriptive information 148 from storage on a computing device (e.g. server 150) upon request.

Media data 170 together with directly or indirectly associated metadata (e.g. descriptive information 148) may be stored in the same location or separate locations, and may be stored locally on capture device 130 or stored remotely on another device (e.g. server 150). In one embodiment, media data 170 together with directly associated metadata (e.g. descriptive information 148) are stored as an image file such as but not limited to a JPEG, TIFF, etc.

In one embodiment, media data 170 together with associated metadata (e.g. descriptive information 148) can be stored as an image file such that the content of media data 170 is presented in combination with a dynamic element (e.g. a “clickable button that appears on the content of media data 170) such that when the dynamic element is activated (e.g. by tapping on a mobile device or scrolling-over with a mouse on a computer, etc.) descriptive information 148 is presented and accessible to a user. Button activation can be a functionalized by incorporating a browser plug-in to Chrome®, Explorer®, Safari® as well as Facebook®, Instagram®, Tumblr® and Twitter® such that transferring media data 170 with descriptive information 148 associated therewith (either directly or indirectly) to one of these platforms, the plug-in enables function described herein (e.g. appearance and activation of descriptive information 148), for example.

Associator 200 of capture device 130 associates the selected descriptive information 148 with media data 170 as metadata. Associator 200 may execute in parallel with the creation of media data 170 or may be executed after creating media data 170. In an embodiment where associator 200 associates the selected descriptive information 148 with media data 170 after the creation of media data 170, descriptive information 148 is temporarily stored at collection module 132 at capture device 130 for user 101 to select which descriptive information 148 to associate with media data 170. In this embodiment, capture device 130 can time-stamp descriptive information 148 received from target devices 110 proximate to capture device 130 when capture device 130 captures an image (either static or moving) and creates media data 170. At a point in time after the time of creation of media data 170, user 101 can access descriptive information 148 corresponding to the time of creation of media data 170 and selectively associate descriptive information 148 with media data 170 using associator 200.

In another embodiment, user 101 of the capture device 130 can access descriptive information 148 (either as stored on capture device 130 or accessed from storage on server 150, via display 139 of capture device 130) according to a time-stamp associated with descriptive information 148 to ascertain when descriptive information 148 was captured.

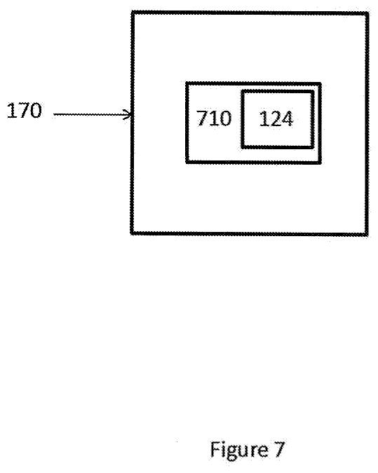

Turning to FIG. 7, an embodiment where media data 170 is a video file is shown.

In one embodiment, the capture device 130 can capture media data 170 as a video file. In this embodiment, capture device 130 can trigger receipt or processing of signals 115 received from target devices 110. In one example, during the capture of media data 170 as a video, capture device 130 can receive signals 115 from target devices 110 proximate to capture device 130 intermittently (e.g. capture device can receive signals 115 at set or varying intervals) and stored as a sidecar file 710. A user 101 of capture device 130 can therefore receive signals 115 intermittently (e.g. at set or varying intervals) during the capture of media data 170 from a plurality of target devices 110. Herein, the term “sidecar file” refers to a computer file that stores data (often metadata) that may not be supported by the format of a source file (e.g. media data 170). In one embodiment, sidecar file 710 is associated with media data 170 (i.e. the source file) based on the file name. For example, sidecar file 710 and media data 170 may have a same base name but a different extension.

In this example, capture device 130 can receive signals 115 over time and incorporate descriptive information 148 received from target devices 110 (either directly or indirectly as previously described) into video media data 170 as content-specific metadata.

In this embodiment, descriptive information 148 can be associated with video file 170 as a sidecar file 710 that may be time synchronized for presentation in parallel with the presentation of content of video file 170. For example, sidecar file 710 can be presented concurrently with video file 170 and provide descriptive information 148 to users viewing the video file according to the embodiments described below.

The resulting stored video file 170 with sidecar file 710 presenting descriptive information 148 can be presented on the display 139 of capture device 130. Sidecar file 710 can be viewed as a timeline 721 where user 101 can scroll (e.g. navigates) the timeline (e.g. using a drag motion on a touch screen, as an example) to view various representations (either individually or as part of a list presented according to the previously described embodiments) received by capture device 130 intermittently while capturing video file 170.

Sidecar file 710 can be presented on capture device 130 including a plurality of representations 124. For example, representations 124 represent descriptive information 148 available from target device 110 that can be associated with video file 170 as sidecar file 710. Representations 124 can be presented in lists (as previously described) and are selectable by capture user 101 as input. As capture user 101 selects a representation 124 (e.g. using a touch screen display 139 of capture device 130, for example), descriptive information 148 made available by target user 102 is associated with a time point of video media data 170 using a timestamp generated by one of capture device 130 and target device 110 at the time that descriptive information 148 was captured by capture device 130. In one example, user 101 can select representations 124 to associate with video file 170 in sidecar file 710 at a time point of the video media data 170 when the user 102 corresponding with descriptive information 148 is visually present (e.g. a content item) in video media data 170.

In another embodiment, when selecting representations 124 to associate corresponding descriptive information 148 with video file 170, user 101 can select a time period for descriptive information 124 to be available (e.g. presented) during the presentation of video media data 170 and associated sidecar file 710. In this manner, user 101 can control presentation of descriptive information 148 during playback of video file 170 to provide descriptive information 148 for periods of time longer than, for example, target device 110 was proximate to capture device 130 during the capture of video media data 170. For example, user 101 can select a representation 124 to associate its corresponding descriptive information 148 with video media data 170 such that the corresponding descriptive information 148 is presented as side car file 710 from a point in video media data 170 2 minutes and 30 seconds from the beginning of the video media data 170 to a point 5 minutes and 15 seconds from the beginning of video media data 170. It should be noted that this period of time may or may not correlate to the period of time that an object/service/person corresponding to descriptive information 148 is shown in video media data 170.

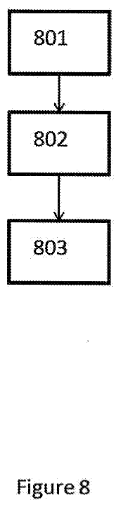

FIG. 8 shows a flow diagram for a process of associating descriptive information 148 to media data 170 (e.g. a static or moving image, video file 170) according to an embodiment.

In step 801, a user operating capture device 130 captures media data 170 (e.g. captures a digital photograph/video/sound with a device capable of capturing content (e.g. with a digital camera, mobile device, tablet, smart phone, etc). Media data 170 can be stored on capture device 130 or on server 150 as a digital image or digital video file (e.g. .JPG, .TIFF, .MOV, .WAV or the like)

In step 802, capture device 130 receives beacon signal 115 with embedded beacon data 117 from one or more target devices 110 in proximity to the capture device 130 at a time of capture of media data 170. Beacon signal 115 with embedded beacon data 117 is received by the user device over any wireless medium including but not limited to Wi-Fi, cellular or Bluetooth technology as described above.

In step 803, user 101 selects representation 404 presented on a display 139 of capture device 130 to associate descriptive information 148 associated with representation 404 to media data 170. Descriptive information 148 can include information embedded within signal 115 from one or more target devices 110 or can be retrieved from another computing device (e.g. 150) using instructions embedded within beacon signal 115. User 101 selection of representation 404 to associate its associated descriptive information 148 with media data 170 can be based on a content item 149 within the content captured by capture device 130. For example, upon capture (e.g. generation) of media data 170, user 101 can view one or more individuals presented as a content item 149 of media data 170 presented on display 139 of capture device 130.

In step 804, upon receipt of the selection of one or more representations 404, associator 200 of capture device 130 associates descriptive information 148 associated with each corresponding selected representation 404 as metadata in association with the media data 170. In one embodiment, associator 200 directly associates descriptive information 148 with media data 170 as metadata where the metadata has a format conforming to a standard or the like which may be defined using XMP or the like. In another embodiment, associator 200 indirectly associates descriptive information 148 with media data 170 as metadata where the metadata is stored on a computing device (e.g. server 150) and retrieved for presentation with media data 170 upon request by a user.

### Exchange of Media Data with Associated Descriptive Information

Once media data 170 has been captured and descriptive information 148 has been associated therewith, either in the form of an image file, a video file or a sound file as previously described, sharing module 403 can transfer media data 170 using many different mediums.

Various embodiments of systems and methods are described herein to provide a plurality of users with media data 170 and associated descriptive information 148 as metadata accompanying media data 170.

In one embodiment, media data 170 together with descriptive information 148 embedded as metadata can be transmitted directly to another computing device (e.g. over a wireless network). In another example, media data 170 together with descriptive information 148 embedded as metadata can be transmitted directly to a server (e.g. a third party server, not shown) hosting a social networking application where user 101 of capture device 130 (e.g. a social networking site) can upload media data 170 to an account where others can view the content and access the descriptive information (e.g. Facebook®, Instagram®, Tumblr®, Twitter®, etc.). In this embodiment, the social networking application may comprise a plug-in to provide functionality of presenting descriptive information 148 associated with media data 170.

In another example, media data 170 comprising instructions as metadata for the presentation of descriptive information 148 from a computing device can be transmitted directly to another computing device (e.g. over a wireless network). In another example, media data comprising instructions as metadata for the presentation of descriptive information 148 from a computing device can be transmitted directly to a server (not shown) hosting a social networking application (e.g. a social networking site where user 101 of capture device 130 can upload media data 170 to a profile where others can view the content and access the descriptive information (e.g. Facebook®, Instagram®, Tumblr®, Twitter®, etc.). In this embodiment, the social networking application may comprise a plug-in to provide functionality of retrieving and presenting descriptive information 148 associated with media data 170.

In one embodiment, capture device 130 can transmit media data 170 with descriptive information 148 associated therewith as metadata to a third party server-based content sharing platform (not shown) via platform 400 to be shared on the third party server-based content sharing platform on behalf of user 130 as originating therefrom. In this embodiment, platform 400 and/or target device 130 can receive a number of views of the media data 170 and associated metadata (e.g. descriptive information 148) from third party server-based content sharing platform and increment a compensation value associated with the number of views of the media data and associated metadata, the number of views received from the third party server-based content sharing platform upon request by user 101 of platform 400, for example. In this embodiment, third party server-based content sharing platform may comprise a plug-in to provide functionality of receiving a request of the number of views of the media data 170 and associated metadata from capture device 130 and/or providing the number of views of the media data 170 and associated metadata to profile 400.

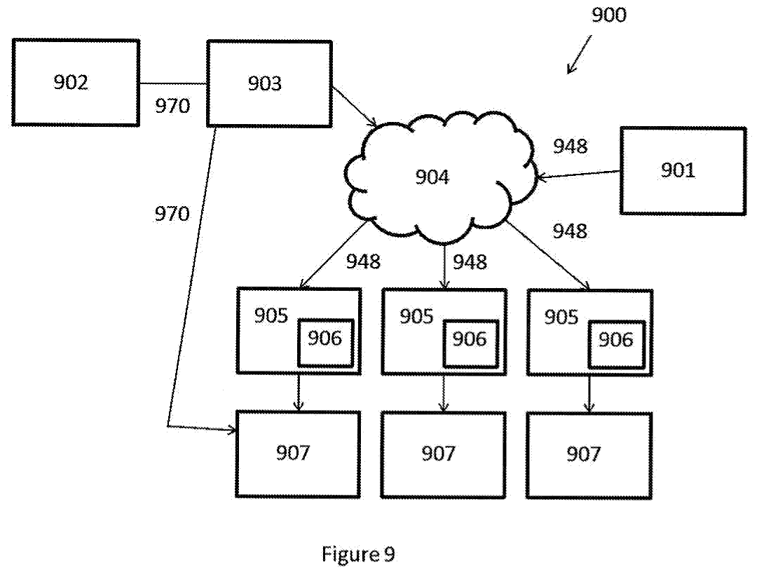

FIG. 9 illustrates another embodiment of a system for providing video file 970 and sidecar file(s) 910 (e.g. as associated metadata providing descriptive information 948) to users 907 in accordance with one embodiment of the systems and methods described herein.

The system in FIG. 9 includes server 901, a presentation device 902, display device 903, network 904, a plurality of user devices 905, application 906 and users 907. Server 901, presentation device 902, display device 903, and user devices 905 may be in wireless communicative contact with one or more other components over network 904.

Server 901 can include a computing system with wired or wireless communication interfaces to communicate with one or more of presentation device 902, display device 903 and user devices 905. Server 901 can be implemented, for example, as a computing system using the Windows®, Apple®, Unix®, Linux®, MacOS®, or other operating system. In one example, server 901 can be local to the theater and communicate with user devices 905 via a wireless access point in the theater. In another example, server 901 can be a server not local to the theater and that communicates with user devices 905 via one of a cellular network, an IP network and a wireless access point, or the like.

Presentation device 902 can be configured to provide or play audio/video content (e.g. media data 970) to one or more users 907 and display device 903 can be configured to receive video media data 970 and present descriptive information 948 of media data 970 for viewing by users 907. In some embodiments, display device 903 and presentation device 902 can be integrated into a single device (e.g. a television). For example, in a movie theatre setting, presentation device 902 can be configured to both project a motion picture onto a screen, to provide a soundtrack to a set of speakers and to provide sidecar file 910 to user devices 905. In another embodiment, such as the system 900 shown in FIG. 9, display device 903 and presentation device 902 are separate devices (e.g. a projector and a computer, respectively) where either one is capable of providing sidecar file 910 to user devices 905. In yet another embodiment of capturing content as a video file 970, video file 970 may be rendered by a separate device (e.g. an ancillary device, not shown) that can provide sidecar file 910 to user devices 905.

In each of the embodiments described above, the device rendering sidecar file(s) 910 to user device 905 correlates timestamps associated with video file 970 with sidecar file(s) 910 such that when a time-stamp associated with the video file 970 is reached during rendering, the device rendering sidecar file(s) 910 to user device 905 can dynamically transmit the correlated time-stamped sidecar file(s) 910 wirelessly over network 904 for presentation of the descriptive information 948 on user devices 905. In the above embodiment where a separate (e.g. ancillary) device is used to render sidecar file 910, time-stamps in video file 970 may be communicated to the ancillary device at correlated times for the ancillary device to re-transmit the descriptive information 948 correlated within sidecar file 910 wirelessly to user devices 905.

Sidecar file(s) 910 may comprise descriptive information 948 for presentation on user devices 905 or may comprise instructions for user devices 905 to retrieve descriptive information 948 from a computing device (e.g. server 901) where descriptive information is stored. User devices 905 may communicate with server 901 over either a local or wide area network (e.g. network 904). Sidecar file(s) 910 can be time-stamped to correlate with a time-stamped of video file 970 such that rendering of sidecar file(s) 910 can be synchronized with rendering video file 970. For example, descriptive information 948 may include but is not limited to text, audio-video, video, clips, chat, comments or images.

In some embodiments, descriptive information 948 can provide static information 920 to a user 907 of user device 905, where static information 920 describes at least a portion of the video file presented to the user (e.g. via presentation device 902 and display device 903). For example, static information 920 can include the manufacturer of a car visible as content of video file 970, the name of an actor portraying a character visible as content of video file 970 or the name of make-up artist that provide make-up to a character visible as content of video file 970. In other embodiments, descriptive information 948 can provide dynamic information 921, where dynamic information 921 is executable by user 907 of user device 905. For example, dynamic information 921 may include a hyperlink to a website where user 907 of user device 905 can purchase a handbag that is being carried by an actor visible as content of video file 970.

User devices 905 can be fixed (e.g., fixed to seats in the theater) or portable electronic devices such as but not limited to iPads®, tablet computers, iPhones®, Kindles®, Android® devices, or other tablets, mobile phones or computing devices operating a mobile device platform to enable communication between server 901 and user devices 905.

In one embodiment, an application 906 is installed on each user device 905 to provide users 907 with descriptive information 948 from sidecar file 910 according to the above-described embodiments (including system 900). Application 906 executing on user device 905 presents descriptive information 948 in sync with the presentation of video file 170 on display device 903. In this manner, users 907 can be provided with descriptive information 948 associated with content items presented on display device 903.

For example, in an embodiment of video file 170 being a motion picture presented to users 907 in an theatre audience, descriptive information 948 can include but is not limited to descriptive information of actors, characters, objects and or services being presented as video file 170. Descriptive information can include textual information, picture information and/or hyperlinks to connect user devices 905 to other servers where users 907 can retrieve further information regarding content items of video file 970.

In one embodiment, application 906 receives sidecar file 970 from one of presentation device 902, display device 903 and server 901 and decodes sidecar file 910 to extract descriptive information 948 for presentation on user device 905. In another embodiment, application 906 receives descriptive information 948 directly from one of presentation device 902, display device 903 and server 901 for presentation on user device 905.

As previously described, video file 970 and sidecar file 910 can comprise tags 911a and 911b, respectively, to synchronize the presentation of descriptive information 948 on user devices 905 with the presentation of video file 170 by presentation device 902, for example. In one embodiment, tag 911b of sidecar file 910 can be linked to a time code of play of video file 970 such that presentation device 902 and/or display device 903 and/or server 901 (whichever device is rendering video file 970) can detect tag 911b upon reaching the time code of play in video file 970 and render the descriptive information of the sidecar file 910 at the time code of play for display on user devices 905 (e.g. for presentation to users of user devices 905).

In another example, in embodiments above where video file 970 and sidecar file 910 are rendered by single device, time code data 911a of video file 970 and time code data 911b of sidecar file 910 can be periodically or constantly matched (e.g. correlated) to ensure that video file 970 and sidecar file 910 are presented in sync (e.g. synchronized or at the same time as indicated using a time code) with each other. In one embodiment, pre-defined location markers, such as chapter markers, may also be used to synchronize the video file 970 and sidecar file 910.

In embodiments where video file 970 and sidecar file 910 are rendered by separate devices (e.g. by display device 903 and presentation device 902, respectively), the separate devices can communicate time code data 911a and/or time code data 911b to each other (e.g. over a wireless network) periodically or constantly to ensure that matched (e.g. correlated) video file 970 and sidecar file 910 are presented in sync (e.g. synchronized or at the same time) with each other.

In another embodiment where video file 970 and sidecar file 910 are rendered by separate devices (e.g. by display device 903 and presentation device 902, respectively), communication between the separate devices can be through server 901.

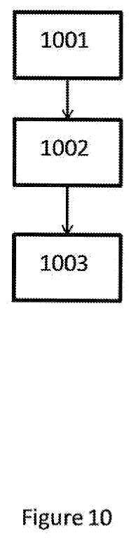

FIG. 10 illustrates an example process for providing descriptive information 948 to one or more user devices 905 in accordance with the embodiments described herein.

In FIG. 10, at step 1001, application 906 is installed on user devices 905. As previously described, application 906 receives descriptive information 948 from one of presentation device 902, display device 903 and server 901 present descriptive information 948 on user device 905.

At step 1002, when in the theater, for example, each user device 905 connects to server 901 (e.g. by pressing an icon presented by application 906 on a display of user device 905) through network 904, for example, where network 904 can be an IEEE 802.11 Wi-Fi network connection, a cellular (e.g., 3G or 4G) connection, a short range wireless connection or other communication connection. In other embodiments, system 900 can be configured such that user devices 905 connect with server 901 before user 907 enters the theater, for example. In another embodiment, user 907 connects to server 901 by opening application 906 on user device 905 and logs into application 906 using a password, for example.

At step 1003, video file 970 and sidecar file 910 are rendered in synch such that content items of video file 970 are presented on display device 903 to users 907 and descriptive information 948 associated with video media data 970 is presented on user device 905 via application 906. It should be noted that the descriptive information 948 associated with the video file 970 presented by display device 903 can be downloaded and/or streamed to user device 905 from server 904 as the user is viewing the video file 170. Descriptive information 948 is presented on user device 905 such that user 907 of user device 905 can access the descriptive information 948 in real-time. In other embodiment, descriptive information 948 can be stored on user device 905 to be accessed at a later time.

While the foregoing has been described in some detail for purposes of clarity and understanding, it will be appreciated by one skilled in the art, from a reading of the disclosure that various changes in form and detail can be made without departing from the true scope of the invention in the appended claims. It will be appreciated that while various embodiments are described herein, any of the embodiments may comprise the features and functions of any other embodiments unless explicitly stated to be otherwise true. It will be understood that the various devices and components described herein may comprise the features and functions of other devices and components described herein unless explicitly stated to be otherwise true. For example, a target device may have the features and functions of a capture device and vice versa.

All publications, patents, and patent applications are herein incorporated by reference in their entirety to the same extent as if each individual publication, patent or patent application was specifically and individually indicated to be incorporated by reference in its entirety.

1. A capture device having a processor coupled to a memory, an input device and a communication module, the memory storing instructions, which when executed by the processor, configure the capture device to:
receive media data;
receive beacon data from a target device proximate to the capture device when the media data is received, the beacon data received at the communication module of the capture device wirelessly from the target device;
obtain descriptive information from the beacon data or using the beacon data where the descriptive information describes a content item; and
associate the descriptive information with the media data as metadata.

2. The capture device of claim 1 wherein the capture device is configured to obtain the descriptive information from the target device or another external communication device in accordance with the beacon data.

3. The capture device of claim 1 configured to:
receive a representation where the representation corresponds to the descriptive information describing the content item;
present the media data and the at least one representation on a display of the capture device; and
receive as input a selection of at least one of the at least one representation; and
wherein the corresponding descriptive information of each selected representation is associated with the media data as metadata in response to the selection.

4. The capture device of claim 3, further configured to:
responsive to the selection of the representation:
request the corresponding descriptive information for the representation as selected from the target device or another external communication device; and
receive the descriptive information.

5. The capture device of claim 1, wherein the media data is image data captured by an image input device of the capture device.

6. The capture device of claim 1, wherein the content item is visually depicted in the media data.

7. The capture device of claim 1, wherein the descriptive information is an image of the content item in the image data.

8. The capture device of claim 1, further configured to:
transmit the media data and associated metadata to a third party server-based content sharing platform to be shared thereon.

9. The capture device of claim 7, further configured to:
increment a compensation value associated with a number of views of the media data and associated metadata, the number of views received from the third party server-based content sharing platform.

10. The capture device of claim 1 configured to:
receive respective beacon data from respective target devices proximate to the capture device when the media data is received, the respective beacon data received at the communication module of the capture device wirelessly from the respective target devices;
obtain respective descriptive information from at least some of the respective beacon data or using at least some of the respective beacon data where the respective descriptive information describes a respective content item; and
associate the respective descriptive information as obtained with the media data as metadata.

11. The capture device of claim 10 configured to:
receive respective representations where each representation corresponds to descriptive information describing each respective content item;
present the media data and the respective representations on a display of the capture device;
receive as input a selection of at least one of the representations; and
wherein the corresponding descriptive information is associated with the media data as metadata in response to the selection.

12. The capture device of claim 10 wherein each respective target device comprises a beacon transmitting the respective beacon signal comprising the respective beacon data; wherein each target device is associated with one or more content items and wherein the capture device comprises a camera to receive the media data as image data captured by the camera where the image data includes data for at least some of the content items associated with each target device.

13. The capture device of claim 1 wherein a particular target device is associated with one or more particular content items in a profile stored at another external communication device, each content item having respective descriptive information; wherein the other external communication device communicates the respective descriptive information to the particular target device or the capture device; and wherein the capture device either obtains the description information from the particular target device as a component of the beacon data received from the particular target device or from the other external communication device using the beacon data received from the particular target device.

14. The capture device of claim 13 configured to request a representation associated with the particular target device from the other external communication device using the beacon data, the representation comprising a textual or visual identifier for a user of the particular target device.

15. The capture device of claim 13 wherein the profile comprises a sharable portion for sharing information with capture devices, the sharable portion comprising representations for specific content items, each having associated descriptive information and wherein the capture device is configured to obtain the associated descriptive information upon receiving the media data and using the beacon data.

16. A computer implemented method for a capture device, the method comprising:
receiving media data at the capture device;
receiving beacon data at the capture device from a target device proximate to the capture device when the media data is received, the beacon data received at a communication module of the capture device wirelessly from the target device;
obtaining descriptive information from the beacon data or using the beacon data where the descriptive information describes a content item; and
associating the descriptive information with the media data as metadata.

17. The method of claim 16 comprising obtaining the descriptive information from the target device or another external communication device in accordance with the beacon data.

18. The method of claim 16 comprising:
receiving a representation where the representation corresponds to the descriptive information describing the content item;
presenting the media data and the at least one representation on a display of the capture device; and
receiving as input from a selection of at least one of the at least one representation; and
wherein the corresponding descriptive information of each selected representation is associated with the media data as metadata in response to the selection.

19-31. (canceled)

32. A computing device having a processor coupled to a memory, an input device and a communication module, the memory storing instructions, which when executed by the processor, configure the computing device to:
access a profile comprising a plurality of representations of content items, each representation of the plurality of representations having metadata providing descriptive information of a corresponding content item;
transfer at least one of the plurality of representations to a sharable portion of the profile, the sharable portion of the profile accessible by a capture device over a network; and
transmit a wireless signal by the communication module for receipt by the capture device, the wireless signal comprising instructions for the capture device to access the sharable portion of the profile and retrieve the descriptive information of each corresponding content item of the at least one representation transferred to the sharable portion of the profile.

33. (canceled)

34. A computing device having a processor coupled to a memory and coupled to an input device, the memory storing instructions, which when executed by the processor, configure the computing device to:
identify media data having content to be rendered, the media data having associated metadata, the metadata comprising at least one tag linked to a time code of play in the media data, the tag associated with descriptive information of the content of media data;
render the media data to an audience;
upon reaching the time code of play in the media data, detect the tag linked to the time code of play;
retrieve the descriptive information associated with the tag; and
transmit the descriptive information to at least one device over a wireless network such that the descriptive information is presented by the device for viewing.

35. (canceled)
